(19) United States
(12) Patent Application Publication
(10) Pub. No.: US 2005/0259365 A1
(43) Pub. Date: Nov. 24, 2005

(54) Magnetoresistive sensor with a specular scattering layer formed by deposition from an oxide target

(75) Inventors: Eric Walter Singleton, Maple Plain, MN (US); Kristin Joy Duxstad, Eden Prairie, MN (US); Qing He, Plymouth, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Seagate Technology LLC, Scotts Valley, CA (US)

(21) Appl. No.: 10/198,918

(22) Filed: Jul. 19, 2002

Related U.S. Application Data
(60) Provisional application No. 60/362,906, filed on Mar. 8, 2002.

(51) Int. Cl. G11B 5/39

(52) U.S. Cl. 360/324.1; 29/603.07

(57) ABSTRACT

A magnetoresistive stack having a plurality of layers, characterized by an oxide specular scattering layer formed by deposition from an oxide target. The specular scattering layer is preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅, and preferably has a thickness in the range of about 3 Å to about 25 Å.

### CROSS-REFERENCE TO RELATED APPLICATION(S)

This application claims priority from Provisional Application No. 60/362,906, filed Mar. 8, 2002 entitled “Novel Method Of Manufacturing A Thin Film Spin Valve Sensor With Specular Scattering Layer Formed By RF Deposition And A Cu Dusting Layer” by E. Singleton, K. Duxstad, and Q. He.

### BACKGROUND OF THE INVENTION

The present invention relates generally to a magnetoresistive sensor for use in a magnetic read head. In particular, the present invention relates to a magnetoresistive read sensor having an oxide specular scattering layer formed by deposition from an oxide target.

Magnetoresistive read sensors, such as giant magnetoresistive (GMR) read sensors, are used in magnetic data storage systems to detect magnetically-encoded information stored on a magnetic data storage medium such as a magnetic disc. A time-dependent magnetic field from a magnetic medium directly modulates the resistivity of the GMR read sensor. A change in resistance of the GMR read sensor can be detected by passing a sense current through the GMR read sensor and measuring the voltage across the GMR read sensor. The resulting signal can be used to recover the encoded information from the magnetic medium.

A typical GMR read sensor configuration is the GMR spin valve, in which the GMR read sensor is a multi-layered structure formed of a nonmagnetic spacer layer positioned between a ferromagnetic pinned layer and a ferromagnetic free layer. The magnetization of the pinned layer is fixed in a predetermined direction, typically normal to an air bearing surface of the GMR read sensor, while the magnetization of the free layer rotates freely in response to an external magnetic field. The resistance of the GMR read sensor varies as a function of an angle formed between the magnetization direction of the free layer and the magnetization direction of the pinned layer. This multi-layered spin valve configuration allows for a more pronounced magnetoresistive effect, i.e. greater sensitivity and higher total change in resistance, than is possible with anisotropic magnetoresistive (AMR) read sensors, which generally consist of a single ferromagnetic layer.

One principal concern in the performance of GMR read sensors is the GMR ratio. GMR ratio (the maximum absolute change in resistance of the GMR read sensor divided by the resistance of the GMR read sensor multiplied by 100%) determines the magnetoresistive effect ofthe GMR read sensor. Ultimately, a higher GMR ratio yields a GMR read sensor with a greater magnetoresistive effect which is capable of detecting information from a magnetic medium with a higher linear density of data.

A popular method of increasing the GMR ratio of a GMR read sensor is the incorporation of a specular scattering layer in the GMR read sensor. Specular scattering layers are generally positioned adjacent to the free layer (or other ferromagnetic layer), and enhance the GMR ratio by increasing the effective electron mean free path in the GMR read sensor, and in particular the free layer.

However, there are several problems with specular scattering layers. From a manufacturing point of view, specular scattering layers have stringent requirements including layer thickness, film stoichiometry, and the ability to enhance the GMR ratio without resulting in poor magnetic properties. In addition, specular scattering layers are sensitive to additionally deposited cap layers, where the cap layer often reduces or completely eliminates the specularity (GMR ratio enhancement) of the specular scattering layer.

A further problem arises when an oxide specular scattering layer is used. Oxide layers are typically formed by initially depositing a layer of metallic material and then carefully oxidizing the metallic layer after it is deposited. This method has several disadvantages for volume production of GMR read sensors. The oxidation process of the metallic layer requires careful control to ensure the ferromagnetic layers of the GMR read sensor are not oxidized in the latter oxidation process. In addition, the oxide layer formation is incompatible with the deposition chamber used for the other layers of the GMR read sensor, and process repeatability and control is poor.

The present invention addresses these and other needs, and offers other advantages over current devices.

### BRIEF SUMMARY OF THE INVENTION

The present invention is a magnetoresistive stack having a plurality of layers, characterized by an oxide specular scattering layer formed by deposition from an oxide target. The specular scattering layer is preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅, and preferably has a thickness in the range of about 3 Å to about 25 Å.

### BRIEF DESCRIPTION OF THE DRAWINGS

FIG. 1 is a layer diagram of a prior art GMR stack.

FIG. 2 is a layer diagram of a first embodiment of a GMR stack of the present invention.

FIG. 3 is a graph of the magnetic properties of a GMR stack utilizing various capping layers.

FIG. 4 is a response surface of the exchange coupling field between the free layer and the pinned layer of the first embodiment of a GMR stack of the present invention.

FIG. 5 is a response surface of the GMR ratio of the first embodiment of a GMR stack of the present invention.

FIG. 6 is a layer diagram of a second embodiment of a GMR stack of the present invention.

FIG. 7 is a layer diagram of a third embodiment of a GMR stack of the present invention.

FIG. 8 is a layer diagram of a fourth embodiment of a GMR stack of the present invention.

FIG. 9 is a layer diagram of a fifth embodiment of a GMR stack of the present invention.

### DETAILED DESCRIPTION

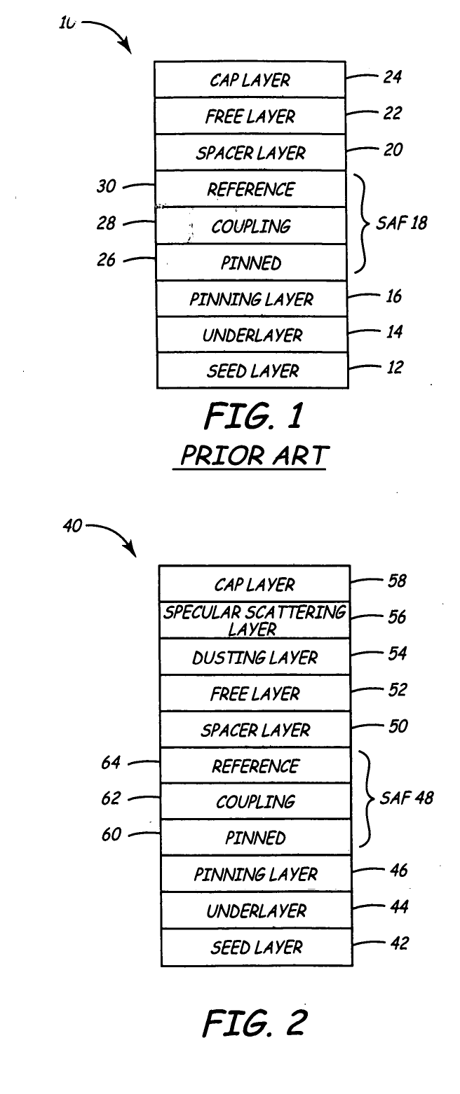

FIG. 1 is a layer diagram of a prior art giant magnetoresistive (GMR) stack 10. Prior art GMR stack 10 includes a seed layer 12, an underlayer 14, a pinning layer 16, a synthetic antiferromagnet (SAF) 18, a spacer layer 20, a free layer 22, and a cap layer 24. Underlayer 14 is a ferromagnetic material and is positioned adjacent to seed layer 12. Pinning layer 16 is an antiferromagnetic material and is positioned adjacent to underlayer 14. SAF 18 includes a ferromagnetic pinned layer 26, a ferromagnetic reference layer 30, and a coupling layer 28 positioned between pinned layer 26 and reference layer 30, and is positioned such that pinned layer 26 is adjacent to pinning layer 16. Free layer 22 is a ferromagnetic material. Spacer layer 20 is a nonmagnetic material and is positioned between SAF 18 and free layer 22. Cap layer 24 is positioned adjacent to free layer 22.

The magnetization of SAF 18 is fixed, while the magnetization of free layer 22 rotates freely in response to an external magnetic field emanating from a magnetic medium. Reference layer 30 and pinned layer 26 are magnetically coupled by coupling layer 28 such that the magnetization direction of reference layer 30 is opposite to the magnetization direction of pinned layer 26. The magnetization of pinned layer 26 is pinned by exchange coupling pinning layer 16 with pinned layer 26. Underlayer 14 promotes the crystallographic texture of pinning layer 16, and seed layer 12 enhances the grain growth of underlayer 14. The resistance of prior art GMR stack 10 varies as a function of an angle that is formed between the magnetization of free layer 22 and the magnetization of reference layer 30.

FIG. 2 is a layer diagram of a first embodiment of a giant magnetoresistive (GMR) stack 40 of the present invention. GMR stack 40 is configured as a bottom spin valve (BSV), and includes a seed layer 42, an underlayer 44, a pinning layer 46, a synthetic antiferromagnet (SAF) 48, a spacer layer 50, a free layer 52, a dusting layer 54, a specular scattering layer 56, and a cap layer 58. Underlayer 44 is preferably a ferromagnetic material, and is positioned adjacent to seed layer 42. Pinning layer 46 is an antiferromagnetic material, and is positioned adjacent to underlayer 44. SAF 48 includes a ferromagnetic pinned layer 60, a ferromagnetic reference layer 64, and a coupling layer 62 positioned between pinned layer 60 and reference layer 64, and is positioned such that pinned layer 60 is adjacent to pinning layer 46. Free layer 52 is a ferromagnetic material. Spacer layer 50 is a nonmagnetic material and is positioned between SAF 48 and free layer 52. Dusting layer 54 is preferably Cu or CuAg, and is positioned adjacent to free layer 52. Specular scattering layer 56 is an oxide material, preferably selected from the group consisting of Al₂O₃, Y₂O₃, HfO₂, ZrO₂, Ta₂O₅, Ti₂O₃ and Ti₃O₅, and is positioned adjacent to dusting layer 54. Cap layer 24 is a chemically stable material, preferably selected from the group consisting of TaN, Ta, Y₂O₃, SiO₂, SiN and AlN, and is positioned adjacent to specular scattering layer 56.

The magnetization of SAF 48 is fixed, while the magnetization of free layer 52 rotates freely in response to an external magnetic field emanating from a magnetic medium. Reference layer 64 and pinned layer 6Q are magnetically coupled by coupling layer 62 such that the magnetization direction of reference layer 64 is opposite to the magnetization direction of pinned layer 60. The magnetization of pinned layer 60 is pinned by exchange coupling pinning layer 46 with pinned layer 60. Underlayer 44 promotes the crystallographic texture of pinning layer 46, and seed layer 42 enhances the grain growth of underlayer 44. The resistance of GMR stack 40 varies as a function of an angle that is formed between the magnetization of free layer 52 and the magnetization of reference layer 64.

Specular scattering layer 56 enhances the GMR ratio of GMR stack 40 by increasing the effective electron mean free path in GMR stack 40 and, in particular, free layer 52. The thickness of specular scattering layer 56 is preferably in the range of about 5 Å to about 25 Å, and more preferably about 10 Å to about 20 Å. Dusting layer 54 preserves the magnetic properties of free layer 52, while continuing to allow specular scattering layer 56 to enhance the GMR ratio of GMR stack 40 due to the relatively long electron mean free path of dusting layer 54. In addition, dusting layer 54 preserves the GMR ratio enhancement effects of specular scattering layer 56 in the presence of cap layer 58. The thickness of dusting layer 54 is preferably in the range of about 2 Å to about 20 Å. Cap layer 58 functions as a protective layer, and preferably has a thickness in the range of about 20 Å to about 100 Å.

Specular scattering layer 56 is formed by deposition from an oxide target material. In particular, RF, electron beam and ion beam sputtering methods may be used. Oxide target materials that may be used include (but are not limited to) Al₂O₃, Y₂O₃, HfO₂, ZrO₂, Ta₂O₅, Ti₂O₃ and Ti₃O₅. The novel nature of this method is that by using deposition from an oxide target material, an oxide specular scattering layer is deposited in a single step. Because the oxide specular scattering layer is deposited directly, the ferromagnetic layers of the GMR stack are not at risk of oxidation. This method allows a robust range of oxide layer thicknesses, as well as a robust range of oxide layer process parameters. In addition, this method allows the cap layer to be deposited in-situ while maintaining the GMR ratio. Furthermore, appropriately chosen oxides can be deposited in the same chamber as the other layers of the GMR stack for ease of manufacturing, improved process control and repeatability, and broad process latitude.

GMR stack 40 also functions similarly if it is configured as a top spin valve (TSV). In this instance, underlayer 44 is deposited on seed layer 42, specular scattering layer 56 is deposited on underlayer 44, dusting layer 54 is deposited on specular scattering layer 56, free layer 52 is deposited on dusting layer 54, spacer layer 50 is deposited on free layer 52, SAF 48 is deposited on spacer layer 50, pinning layer 46 is deposited on SAF 48, and cap layer 58 is deposited on pinning layer 46.

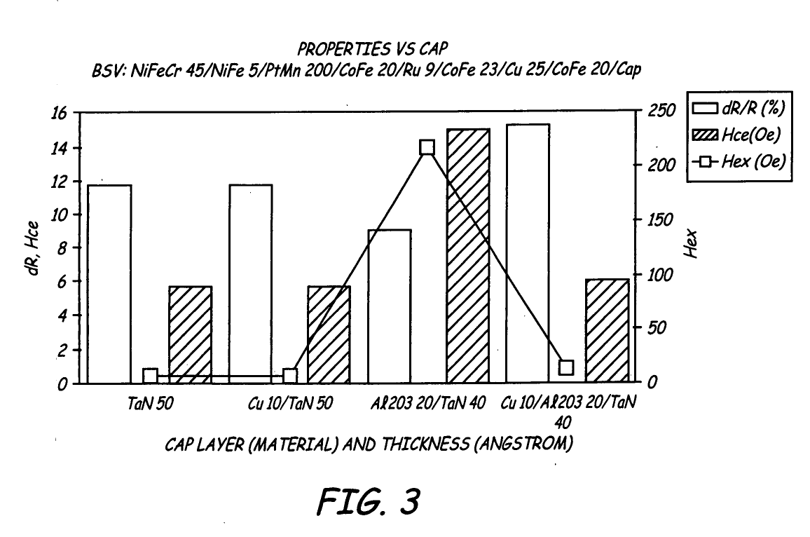

FIG. 3 is a graph of the magnetic properties of a bottom spin valve (BSV) utilizing various capping layers, including the capping layers of GMR stack 40 of FIG. 2. The graph shows the GMR ratio dR/R (%), the free layer coercivity Hce (Oe), and the exchange coupling Hex (Oe) for four separate capping layer structures. The GMR ratio of a BSV with a Cu/Al₂O₃/TaN capping layer structure is greater than 15%, while the other capping layer structures are significantly less. In addition, a BSV with a Cu/Al₂O₃/TaN capping layer structure has an acceptable exchange coupling field between the free layer and the pinned layer of less than 100 Oe, while a BSV with an Al₂O₃/TaN capping layer structure without the Cu layer has an extremely large exchange coupling field of greater than 200 Oe. Finally, the coercivity of the free layer for all capping layer structures is in the range of 5 to 6 Oe, except for the Al₂O₃/TaN capped BSV.

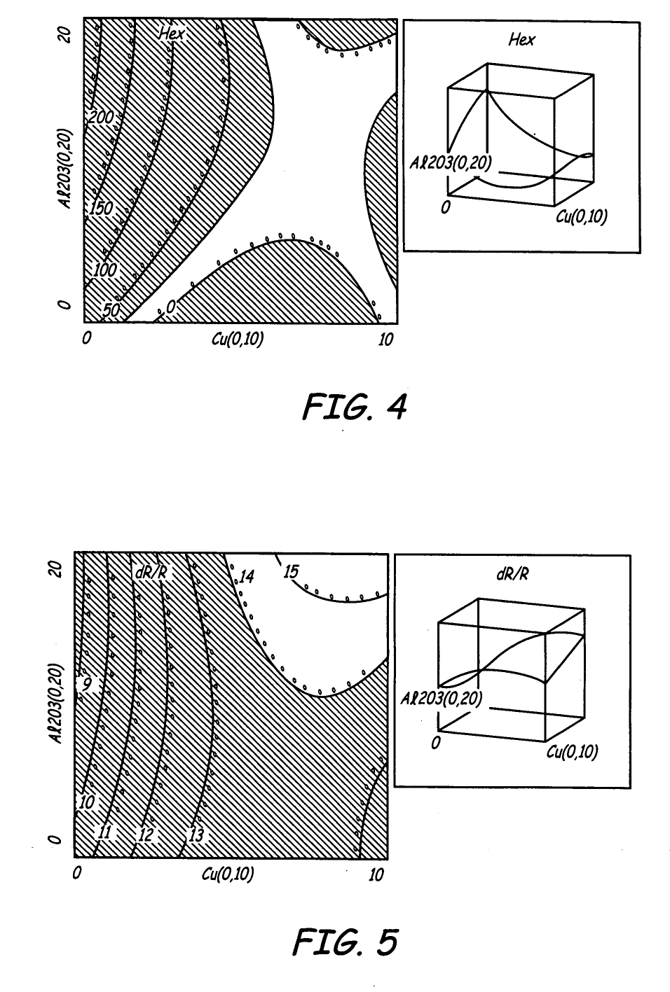

FIG. 4 is a response surface of the exchange coupling field between the free layer and the pinned layers of GMR stack 40 of FIG. 2. The response surface shows the exchange coupling field Hex (Oe) as a function of Cu dusting layer and Al₂O₃ layer thickness (Å). The optimal exchange coupling field is found for Cu dusting layer in the thickness range of about 5 Å to about 10 Å, and Al₂O₃ layer thickness in the range of about 10 Å to about 20 Å.

FIG. 5 is a response surface of the GMR ratio of GMR stack 40 of FIG. 2. The response surface shows the GMR ratio dR/R (%) as a function of Cu dusting layer and Al₂O₃ layer thickness (Å). The optimal GMR ratio is found for Cu dusting layer in the thickness range of about 5 Å to about 1 Å, and Al₂O₃ layer thickness greater than 10 Å.

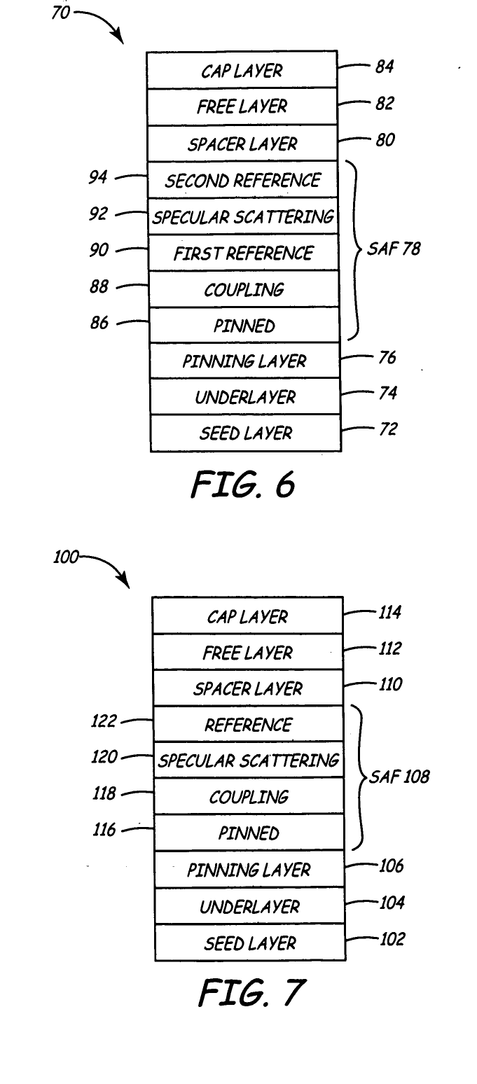

FIG. 6 is a layer diagram of a second embodiment of a giant magnetoresistive (GMR) stack 70 of the present invention. GMR stack 70 is configured as a bottom spin valve (BSV), and includes a seed layer 72, an underlayer 74, a pinning layer 76, a synthetic antiferromagnet (SAF) 78, a spacer layer 80, a free layer 82, and a cap layer 84. Underlayer 74 is preferably a ferromagnetic material, and is positioned adjacent to seed layer 72. Pinning layer 76 is an antiferromagnetic material, and is positioned adjacent to underlayer 74. SAF 78 includes a ferromagnetic pinned layer 86, a coupling layer 88, first and second ferromagnetic reference layers 90 and 94, and an oxide specular scattering layer 92. Pinned layer 86 is positioned adjacent to pinning layer 76. Coupling layer 88 is positioned between pinned layer 86 and first reference layer 90. Specular scattering layer 92 is an oxide material, preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅, and is positioned between first and second reference layers 90 and 94. Free layer 82 is a ferromagnetic material. Spacer layer 80 is a nonmagnetic material and is positioned between SAF 78 and free layer 82. Cap layer 84 is a chemically stable material, preferably selected from the group consisting of TaN, Ta, Y₂O₃, SiO₂, SiN and AlN, and is positioned adjacent to free layer 82.

The magnetization of SAF 78 is fixed, while the magnetization of free layer 82 rotates freely in response to an external magnetic field emanating from a magnetic medium. Reference layers 90 and 94 and pinned layer 86 are magnetically coupled by coupling layer 88 such that the magnetization direction of reference layers 90 and 94 are opposite to the magnetization direction of pinned layer 86. The magnetization of pinned layer 86 is pinned by exchange coupling pinning layer 76 with pinned layer 86. Underlayer 74 promotes the crystallographic texture of pinning layer 76, and seed layer 72 enhances the grain growth of underlayer 74. The resistance of GMR stack 70 varies as a function of an angle that is formed between the magnetization of free layer 82 and the magnetization of reference layers 90 and 94.

Specular scattering layer 92 enhances the GMR ratio of GMR stack 70 by increasing the effective electron mean free path in GMR stack 70 and, in particular, reference layer 94. The thickness of specular scattering layer 92 is preferably in the range of about 3 Å to about 25 Å, and more preferably about 3 Å to about 8 Å. Specular scattering layer 92 is formed by deposition from an oxide target material. In particular, RF, electron beam and ion beam sputtering methods may be used. Oxide target materials that may be used include (but are not limited to) CoO, NiO, CoFeO, Fe₂O_{3,} Fe₃O_{4,} Al₂O₃, Y₂O₃, HfO₂, ZrO₂, Ta₂O₅ , Ti₂O₃ and Ti₃O₅. The novel nature of this method is that by using deposition from an oxide target material, an oxide specular scattering layer is deposited in a single step. Because the oxide specular scattering layer is deposited directly, the ferromagnetic layers of the GMR stack are not at risk of oxidation. This method allows a robust range of oxide layer thicknesses, as well as a robust range of oxide layer process parameters. In addition, this method allows the cap layer to be deposited in-situ while maintaining the GMR ratio. Furthermore, appropriately chosen oxides can be deposited in the same chamber as the other layers of the GMR stack for ease of manufacturing, improved process control and repeatability, and broad process latitude.

GMR stack 70 also functions similarly if it is configured as a top spin valve (TSV). In this instance, underlayer 74 is deposited on seed layer 72, free layer 82 is deposited on underlayer 74, spacer layer 80 is deposited on free layer 82, SAF 78 is deposited on spacer layer 80, pinning layer 76 is deposited on SAF 78, and cap layer 84 is deposited on pinning layer 76.

FIG. 7 is a layer diagram of a third embodiment of a giant magnetoresistive (GMR) stack 100 of the present invention. GMR stack 100 is configured as a bottom spin valve (BSV), and includes a seed layer 102, an underlayer 104, a pinning layer 106, a synthetic antiferromagnet (SAF) 108, a spacer layer 110, a free layer 112, and a cap layer 114. Underlayer 104 is preferably a ferromagnetic material, and is positioned adjacent to seed layer 102. Pinning layer 106 is an antiferromagnetic material, and is positioned adjacent to underlayer 104. SAF 108 includes a ferromagnetic pinned layer 116, a coupling layer 118, an oxide specular scattering layer 120, and a ferromagnetic reference layer 122. Pinned layer 116 is positioned adjacent to pinning layer 106. Coupling layer 118 is positioned between pinned layer 116 and specular scattering layer 120. Specular scattering layer 120 is an oxide material, preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂0₃ and Ti₃0₅, and is positioned between coupling layer 118 and reference layer 122. Free layer 112 is a ferromagnetic material. Spacer layer 110 is a nonmagnetic material and is positioned between SAF 108 and free layer 112. Cap layer 114 is a chemically stable material, preferably selected from the group consisting of TaN, Ta, Y₂O₃, SiO₂, SiN and AlN, and is positioned adjacent to free layer 112.

The magnetization of SAF 108 is fixed, while the magnetization of free layer 112 rotates freely in response to an external magnetic field emanating from a magnetic medium. Reference layer 122 and pinned layer 116 are magnetically coupled by coupling layer 118 such that the magnetization direction of reference layer 122 is opposite to the magnetization direction of pinned layer 116. The magnetization of pinned layer 116 is pinned by exchange coupling pinning layer 106 with pinned layer 116. Underlayer 104 promotes the crystallographic texture of pinning layer 106, and seed layer 102 enhances the grain growth of underlayer 104. The resistance of GMR stack 100 varies as a function of an angle that is formed between the magnetization of free layer 112 and the magnetization of reference layer 122.

Specular scattering layer 120 enhances the GMR ratio of GMR stack 100 by increasing the effective electron mean free path in GMR stack 100 and, in particular, reference layer 122. The thickness of specular scattering layer 120 is preferably in the range of about 3 Å to about 25 Å, and more preferably about 3 Å to about 8 Å. Specular scattering layer 120 is formed by deposition from an oxide target material. In particular, RF, electron beam and ion beam sputtering methods may be used. Oxide target materials that may be used include (but are not limited to) CoO, NiO, CoFeO, Fe₂O_{3,} Fe₃O_{4,} Al₂O₃, Y₂O₃, HfO₂, ZrO₂, Ta₂O₅, Ti₂O₃ Ti₃O₅. The novel nature of this method is that by using deposition from an oxide target material, an oxide specular scattering layer is deposited in a single step. Because the oxide specular scattering layer is deposited directly, the ferromagnetic layers of the GMR stack are not at risk of oxidation. This method allows a robust range of oxide layer thicknesses, as well as a robust range of oxide layer process parameters. In addition, this method allows the cap layer to be deposited in-situ while maintaining the GMR ratio. Furthermore, appropriately chosen oxides can be deposited in the same chamber as the other layers of the GMR stack for ease of manufacturing, improved process control and repeatability, and broad process latitude.

GMR stack 100 also functions similarly if it is configured as a top spin valve (TSV). In this instance, underlayer 104 is deposited on seed layer 102, free layer 112 is deposited on underlayer 104, spacer layer 110 is deposited on free layer 112, SAF 108 is deposited on spacer layer 110, pinning layer 106 is deposited on SAF 108, and cap layer 114 is deposited on pinning layer 106.

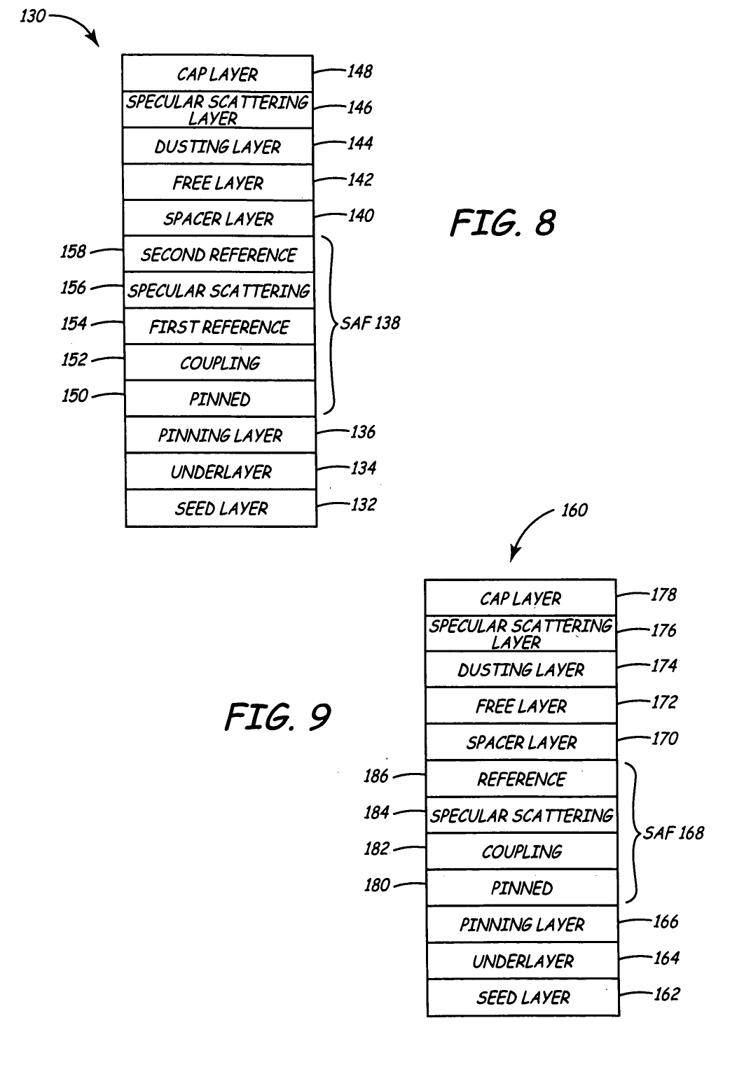

FIG. 8 is a layer diagram of a fourth embodiment of a giant magnetoresistive (GMR) stack 130 of the present invention. GMR stack 130 is configured as a bottom spin valve (BSV), and includes a seed layer 132, an underlayer 134, a pinning layer 136, a synthetic antiferromagnet (SAF) 138, a spacer layer 140, a free layer 142, a dusting layer 144, a specular scattering layer 146, and a cap layer 148. Underlayer 134 is preferably a ferromagnetic material, and is positioned adjacent to seed layer 132. Pinning layer 136 is an antiferromagnetic material, and is positioned adjacent to underlayer 134. SAF 138 includes a ferromagnetic pinned layer 150, a coupling layer 152, first and second ferromagnetic reference layers 154 and 158, and an oxide specular scattering layer 156. Pinned layer 150 is positioned adjacent to pinning layer 136. Coupling layer 152 is positioned between pinned layer 150 and first reference layer 154. Specular scattering layer 156 is an oxide material, preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅, and is positioned between first and second ferromagnetic reference layers 154 and 158. Free layer 142 is a ferromagnetic material. Spacer layer 140 is a nonmagnetic material and is positioned between SAF 138 and free layer 142. Dusting layer 144 is preferably Cu or CuAg, and is positioned adjacent to free layer 142. Specular scattering layer 146 is an oxide material, preferably selected from the group consisting of Al₂O₃, Y₂O₃, HfO₂, ZrO₂, Ta₂O₅, Ti₂O₃ and Ti₃O₅, and is positioned adjacent to dusting layer 144. Cap layer 148 is a chemically stable material, preferably selected from the group consisting of TaN, Ta, Y₂O₃, SiO₂, SiN and AlN, and is positioned adjacent to specular scattering layer 146.

The magnetization of SAF 138 is fixed, while the magnetization of free layer 142 rotates freely in response to an external magnetic field emanating from a magnetic medium. Reference layers 154 and 158 and pinned layer 150 are magnetically coupled by coupling layer 152 such that the magnetization direction of reference layers 154 and 158 are opposite to the magnetization direction of pinned layer 150. The magnetization of pinned layer 150 is pinned by exchange coupling pinning layer 136 with pinned layer 150. Underlayer 134 promotes the crystallographic texture of pinning layer 136, and seed layer 132 enhances the grain growth of underlayer 134. The resistance of GMR stack 130 varies as a function of an angle that is formed between the magnetization of free layer 142 and the magnetization of reference layers 154 and 158.

Specular scattering layer 156 enhances the GMR ratio of stack 130 by increasing the effective electron mean free path in GMR stack 130 and, in particular, reference layer 158. The thickness of specular scattering layer 92 is preferably in the range of about 3 Å to about 25 Å, and more preferably about 3 Å to about 8 Å. Similarly, specular scattering layer 146 enhances the GMR ratio of GMR stack 130 by increasing the effective electron mean free path in GMR stack 130 and, in particular, free layer 142. The thickness of specular scattering layer 146 is preferably in the range of about 5 Å to about 25 Å, an more preferably about 10 Å to about 20 Å. Dusting layer 144 preserves the magnetic properties of free layer 142, while continuing to allow specular scattering layer 146 to enhance the GMR ratio of GMR stack 130 due to the relatively long electron mean free path of dusting layer 144. In addition, dusting layer 144 preserves the GMR ratio enhancement effects of specular scattering layers 146 in the presence of cap layer 148. The thickness of dusting layer 144 is preferably in the range of about 2 Å to about 20 Å. Cap layer 148 functions as a protective layer, and preferably has a thickness in the range of about 20 Å to about 100 Å.

Specular scattering layer 156 is formed by deposition from an oxide target material. In particular, RF, electron beam and ion beam sputtering methods may be used. Oxide target materials that may be used include (but are not limited to) CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅. Similarly, specular scattering layer 146 is formed by deposition from an oxide target material. In particular, RF, electron beam and ion beam sputtering methods may be used. Oxide target materials that may be used include (but are not limited to) Al₂O₃, Y₂O₃, HfO₂, ZrO₂, Ta₂O₅, Ti₂O₃ and Ti₃O₅. The novel nature of this method is that by using deposition from an oxide target material, an oxide specular scattering layer is deposited in a single step. Because the oxide specular scattering layer is deposited directly, the ferromagnetic layers of the GMR stack are not at risk of oxidation. This method allows a robust range of oxide layer thicknesses, as well as a robust range of oxide layer process parameters. In addition, this method allows the cap layer to be deposited in-situ while maintaining the GMR ratio. Furthermore, appropriately chosen oxides can be deposited in the same chamber as the other layers of the GMR stack for ease of manufacturing, improved process control and repeatability, and broad process latitude.

GMR stack 130 also functions similarly if it is configured as a top spin valve (TSV). In this instance, underlayer 134 is deposited on seed layer 132, specular scattering layer 146 is deposited on underlayer 134, dusting layer 144 is deposited on specular scattering layer 146, free layer 142 is deposited on dusting layer 144, spacer layer 140 is deposited on free layer 142, SAF 138 is deposited on spacer layer 140, pinning layer 136 is deposited on SAF 138, and cap layer 148 is deposited on pinning layer 136.

FIG. 9 is a layer diagram of a fifth embodiment of a giant magnetoresistive (GMR) stack 160 of the present invention. GMR stack 160 is configured as a bottom spin valve (BSV), and includes a seed layer 162, an underlayer 164, a pinning layer 166, a synthetic antiferromagnet (SAF) 168, a spacer layer 170, a free layer 172, a dusting layer 174, a specular scattering layer 176, and a cap layer 178. Underlayer 164 is preferably a ferromagnetic material, and is positioned adjacent to seed layer 162. Pinning layer 166 is an antiferromagnetic material, and is positioned adjacent to underlayer 174. SAF 168 includes a ferromagnetic pinned layer 180, a coupling layer 182, an oxide specular scattering layer 184, and ferromagnetic reference layer 186. Pinned layer 180 is positioned adjacent to pinning layer 166. Coupling layer 182 is positioned between pinned layer 180 and specular scattering layer 184. Specular scattering layer 184 is an oxide material, preferably selected from the group consisting of CoO, NiO, CoFeO, Fe₂O_{3,} Fe₃O_{4,} Al₂O₃, Y₂O₃, HfO₂, ZrO₂, Ta₂O₅, Ti₂O₃ and Ti₃O₅, and is positioned between coupling layer 182 and reference layer 186. Free layer 172 is a ferromagnetic material. Spacer layer 170 is a nonmagnetic material and is positioned between SAF 168 and free layer 172. Dusting layer 174 is preferably Cu or CuAg, and is positioned adjacent to free layer 172. Specular scattering layer 176 is an oxide material, preferably selected from the group consisting of Al₂O₃, Y₂O₃, HfO₂, ZrO₂, Ta₂O₅, Ti₂O₃ and Ti₃O₅, and is positioned adjacent to dusting layer 174. Cap layer 178 is a chemically stable material, preferably selected from the group consisting of TaN, Ta, Y₂O₃, SiO₂, SiN and AlN, and is positioned adjacent to specular scattering layer 176.

The magnetization of SAF 168 is fixed, while the magnetization of free layer 172 rotates freely in response to an external magnetic field emanating from a magnetic medium. Reference layer 186 and pinned layer 180 are magnetically coupled by coupling layer 182 such that the magnetization direction of reference layer 186 is opposite to the magnetization direction of pinned layer 180. The magnetization of pinned layer 180 is pinned by exchange coupling pinning layer 166 with pinned layer 180. Underlayer 164 promotes the crystallographic texture of pinning layer 166, and seed layer 162 enhances the grain growth of underlayer 164. The resistance of GMR stack 160 varies as a function of an angle that is formed between the magnetization of free layer 172 and the magnetization of reference layer 186.

Specular scattering layer 184 enhances the GMR ratio of GMR stack 160 by increasing the effective electron mean free path in GMR stack 160 and, in particular, reference layer 186. The thickness of specular scattering layer 184 is preferably in the range of about 3 Å to about 25 Å, and more preferably about 3 Å to about 8 Å. Similarly, specular scattering layer 176 enhances the GMR ratio of GMR stack 160 by increasing the effective electron mean free path in GMR stack 160 and, in particular, free layer 172. The thickness of specular scattering layer 176 is preferably in the range of about 5 Å to about 25 Å, and more preferably about 10 Å to about 20 Å. Dusting layer 174 preserves the magnetic properties of free layer 172, while continuing to allow specular scattering layer 176 to enhance the GMR ratio of GMR stack 160 due to the relatively long electron mean free path of dusting layer 174. In addition, dusting layer 174 preserves the GMR ratio enhancement effects of specular scattering layer 176 in the presence of cap layer 178. The thickness of dusting layer 174 is preferably in the range of about 2 Å to about 20 Å. Cap layer 178 functions as a protective layer, and preferably has a thickness in the range of about 20 Å to about 100 Å.

Specular scattering layer 184 is formed by deposition from an oxide target material. In particular, RF, electron beam and ion beam sputtering methods may be used. Oxide target materials that may be used include (but are not limited to) CoO, NiO, CoFeO, Fe₂O_{3,} Fe₃O_{4,} Al₂O₃, Y₂O₃, HfO₂, ZrO₂, Ta₂O₅, Ti₂O₃ Ti₃O₅. Similarly, specular scattering layer 176 is formed by deposition from an oxide target material. In particular, RF, electron beam and ion beam sputtering methods may be used. Oxide target materials that may be used include (but are not limited to) Al₂O₃, Y₂O₃, HfO₂, ZrO₂, Ta₂O₅, Ti₂O₃ and Ti₃O₅. The novel nature of this method is that by using deposition from an oxide target material, an oxide specular scattering layer is deposited in a single step. Because the oxide specular scattering layer is deposited directly, the ferromagnetic layers of the GMR stack are not at risk of oxidation. This method allows a robust range of oxide layer thicknesses, as well as a robust range of oxide layer process parameters. In addition, this method allows the cap layer to be deposited in-situ while maintaining the GMR ratio. Furthermore, appropriately chosen oxides can be deposited in the same chamber as the other layers of the GMR stack for ease of manufacturing, improved process control and repeatability, and broad process latitude.

GMR stack 160 also functions similarly if it is configured as a top spin valve (TSV). In this instance, underlayer 164 is deposited on seed layer 162, specular scattering layer 176 is deposited on underlayer 164, dusting layer 174 is deposited on specular scattering layer 176, free layer 172 is deposited on dusting layer 174, spacer layer 170 is deposited on free layer 172, SAF 168 is deposited on spacer layer 170, pinning layer 166 is deposited on SAF 168, and cap layer 178 is deposited on pinning layer 166.

Although the present invention has been described with reference to preferred embodiments, workers skilled in the art will recognize that changes may be made in form and detail without departing from the spirit and scope of the invention.

1-27. (canceled)

28. A method of forming a magnetic sensor comprising:
providing a ferromagnetic free layer;
depositing a dusting layer adjacent to the free layer; and
depositing an oxide specular scattering layer adjacent to the dusting layer from an oxide target, wherein the oxide specular scattering layer comprises a nonmagnetic oxide.

29. The method of claim 28 wherein the oxide specular scattering layer is selected from the group consisting of Al₂O₃, Y₂O₃, HfO₂, ZrO₂, Ta₂O₅, Ti₂O₃ and Ti₃O₅.

30. The method of claim 28 wherein the oxide specular scattering layer has a thickness in the range of about 5 Å to about 25 Å.

31. The method of claim 28 wherein the dusting layer is selected from the group consisting of Cu and CuAg.

32. The method of claim 28 wherein the dusting layer has a thickness in the range of about 2 Å to about 20 Å.

33. The method of claim 28 and further comprising depositing a cap layer adjacent to the specular scattering layer.

34. A method of forming a magnetic sensor comprising:
providing a ferromagnetic reference layer; and
depositing an oxide specular scattering layer adjacent to the reference layer, wherein the specular scattering layer is formed by deposition from an oxide target and comprises a nonmagnetic oxide.

35. The method of claim 34 wherein the specular scattering layer is selected from the group consisting of Al₂O₃, Y₂O₃, HfO₂, ZrO₂, Ta₂O₅, Ti₂O₃ and Ti₃O₅.

36. The method of claim 34 wherein the oxide specular scattering layer has a thickness in the range of about 3 Å to about 25 Å.

37. A method of forming a magnetic device by depositing a plurality of layers to form a multilayer stack, characterized by:
forming within the multilayer stack a nonmagnetic oxide specular scattering layer from an oxide target.

38. The method of claim 37, wherein the specular scattering layer is selected from the group consisting of Al₂O₃, Y₂O₃, HfO₂, ZrO₂, Ta₂O₅, Ti₂O₃ and Ti₃O₅.

39. The method of claim 37, wherein the specular scattering layer has a thickness in the range of about 5 Å to about 25 Å.

40. The method of claim 37, wherein depositing a plurality of layers to form a multilayer stack comprises:
depositing a synthetic antiferromagnet (SAF) including a ferromagnetic pinned layer, a coupling layer, and a ferromagnetic reference layer;
depositing a spacer layer on the ferromagnetic reference layer; and
depositing a ferromagnetic free layer on the spacer layer.

41. The method of claim 40, wherein forming within the multilayer stack a nonmagnetic oxide specular scattering layer from an oxide target comprises:
forming a nonmagnetic oxide specular scattering layer from an oxide target adjacent to the ferromagnetic reference layer.

42. The method of claim 40, wherein depositing a plurality of layers to form a multilayer stack further comprises:
depositing a dusting layer on the ferromagnetic free layer.

43. The method of claim 42, wherein the dusting layer is selected from the group consisting of Cu and CuAg.

44. The method of claim 42, wherein the dusting layer has a thickness in the range of about 2 Å to about 20 Å.

45. The method of claim 42, wherein forming within the multilayer stack a nonmagnetic oxide specular scattering layer from an oxide target comprises:
forming a nonmagnetic oxide specular scattering layer from an oxide target on the dusting layer.

46. The method of claim 45, wherein depositing a plurality of layers to form a multilayer stack further comprises:
depositing a cap layer on the nonmagnetic oxide specular scattering layer.

47. The method of claim 37, wherein forming within the multilayer stack a nonmagnetic oxide specular scattering layer from an oxide target comprises RF sputtering the oxide target.

48. The method of claim 37, wherein forming within the multilayer stack a nonmagnetic oxide specular scattering layer from an oxide target comprises electron beam sputtering the oxide target.

49. The method of claim 37, wherein forming within the multilayer stack a nonmagnetic oxide specular scattering layer from an oxide target comprises ion beam sputtering the oxide target.
